(19) United States
(12) Patent Application Publication
(10) Pub. No.: US 2010/0170688 A1
(43) Pub. Date: Jul. 8, 2010

(54) BATTERING RAM WITH REPLACEABLE HEADS

(76) Inventor: Kurt J. Delia, Fremont, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/642,934

(22) Filed: Dec. 21, 2009

Related U.S. Application Data
(60) Provisional application No. 61/142,460, filed on Jan. 5, 2009.

(51) Int. Cl. A62B 3/00; B25D 1/14; B23P 11/00

(52) U.S. Cl. 173/90; 29/254; 29/525.01

(57) ABSTRACT

A battering ram system includes an elongated tubular body with an open end and a pair of laterally-extending handles that can be grasped for swinging the body against a door to break a door down. Interchangeable impact heads are provided, each having an elongated male section fit into an open end of the body, a flange abutting the end when the male section is in the body, and an operative end configured to generate a desired impact against the door. A retainer threads into the body to retain the head to the body, but still the flange transfers energy to the body from the impact and not the retainer. The plurality of impact heads are particularly shaped for specific different tasks, such as oversize heads for weight and large surface, undersized heads for high force and damage, and wedge-shaped heads for prying/wedging.

This application claims benefit under 35 U.S.C. §119(e) of provisional application Ser. No. 61/142,460, filed Jan. 5, 2009, entitled BATTERING RAM WITH REPLACEABLE HEADS, the entire contents of which are incorporated herein in its entirety.

### BACKGROUND

The present invention relates to battering rams, such as are used by SWAT teams and drug raid teams to break down doors.

Battering rams are often used by SWAT teams to break down doors when forced entry is necessary, such as during a drug raid. However, different doors and different situations require different battering rams. For example, sometimes a battering ram with a larger surface impact area and increased weight is desired, while other times a smaller surface impact area is desired in order to generate a more focused “punch” on the door's deadbolt and locks. Still further, sometimes a pointed wedge-shaped tool is desired for creating piercing/prying forces. A problem is that SWAT teams cannot carry (nor purchase and inventory) multiple battering rams, since they are relatively heavy pieces of equipment, they take up space, and they are not inexpensive tools due to their mass and size.

### SUMMARY OF THE PRESENT INVENTION

In one aspect of the present invention, a battering ram includes an elongated tubular body with at least one open end and a pair of laterally-extending handles that can be grasped for swinging the body against a door. The battering ram further includes a replaceable impact head with an elongated male section fit into the open end of the body, a flange abutting the end when the male section is in the body, and an operative end configured to generate a desired impact against the door. A retainer releasably secures the head to the body, but with the flange transferring energy from the impact against the door and not transferring substantial energy to the retainer.

In a narrower aspect, the operative end of the impact head defines an impacting surface at least as large as a transverse cross section of the body.

In a narrower aspect, the operative end of the impact head defines an impacting surface smaller than a transverse cross section of the body.

In a narrower aspect, the operative end of the impact head defines an impacting tip that forms a narrow wedge.

In a narrower aspect, the impact head has a first weight, and includes a second head having a second weight and shape different than the first-mentioned impact head.

In a narrower aspect, the retainer includes a threaded screw that threads through the body and has a tip engaging a mating recess in the head.

In another aspect of the present invention, a battering ram system includes an elongated tubular body with at least one open end and a pair of laterally-extending handles that can be grasped for swinging the body against a door. A plurality of interchangeable impact heads are provided, each having an elongated male section fit into the open end of the body, a flange abutting the end when the male section is in the body, and an operative end configured to generate a desired impact against the door. A retainer retaining the head to the body, but with the flange transferring energy from the impact against the door and not transferring substantial energy to the retainer. The plurality of impact heads are particularly shaped for specific different tasks, and include a first impact head where the operative end of the impact head defines an impacting surface at least as large as a transverse cross section of the body, a second impact head where the operative end of the impact head defines an impacting surface smaller than a transverse cross section of the body, and a third impact head where the operative end of the impact head defines an impacting tip that forms a narrow wedge.

In another aspect of the present invention, a method of constructing a battering ram system comprises steps of providing an elongated tubular body with an open end and a pair of laterally-extending handles that can be grasped for swinging the body against a door, and providing a plurality of interchangeable impact heads each having an elongated male section adapted to fit into the open end of the body, a flange abutting the end when the male section is in the body, and an operative end configured to generate a desired impact against the door. The method further includes selecting one of the impact heads for a particular task, and retaining the selected one head to the body using a retainer on the body, but with the flange being constructed to transfer energy from the impact against the door and not transferring substantial energy to the retainer; whereby the plurality of impact heads can be selectively replaced for specific needs.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a battering ram embodying the present invention.

FIG. 2 is an exploded view of FIG. 1.

FIGS. 3-6 are side, top, bottom, and wedge-end views of FIG. 1.

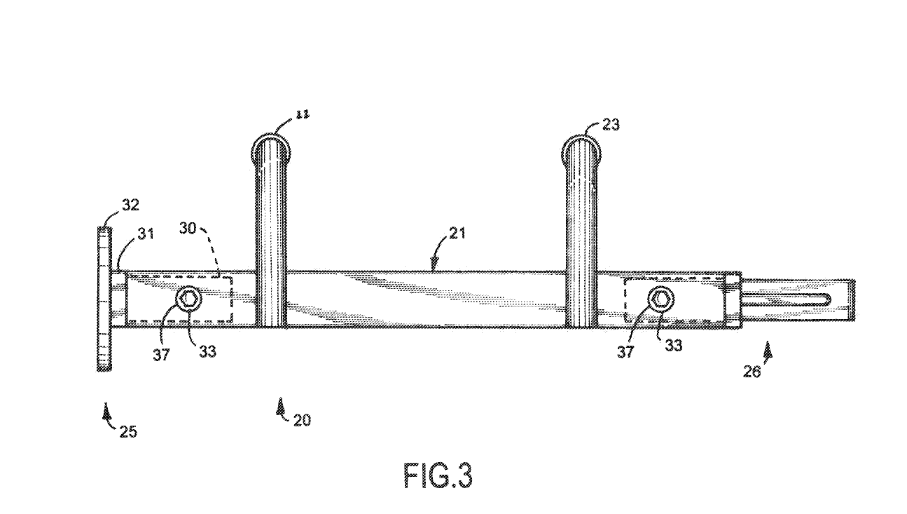

FIGS. 7 and 8 are top views of the ram head and wedge head, respectively, in FIG. 1.

FIG. 9 is a perspective view of the tubular body weldment of FIG. 1.

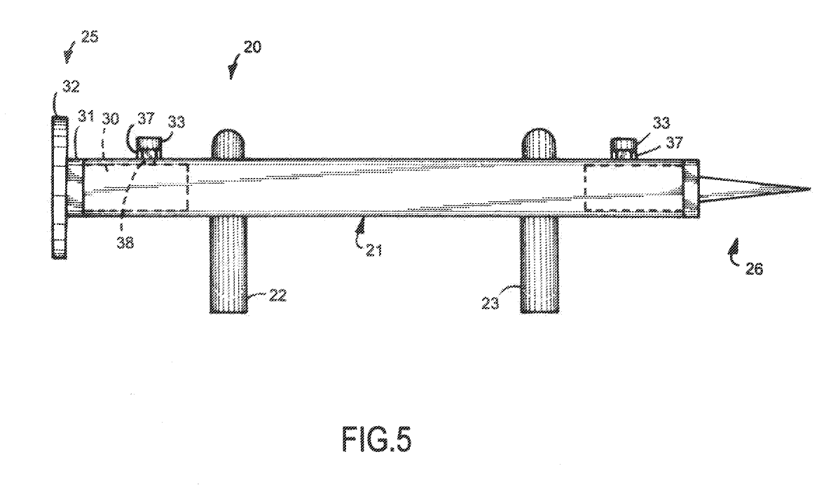

FIG. 10 is a perspective view of a weighted insert for positioning inside the body weldment of FIG. 9.

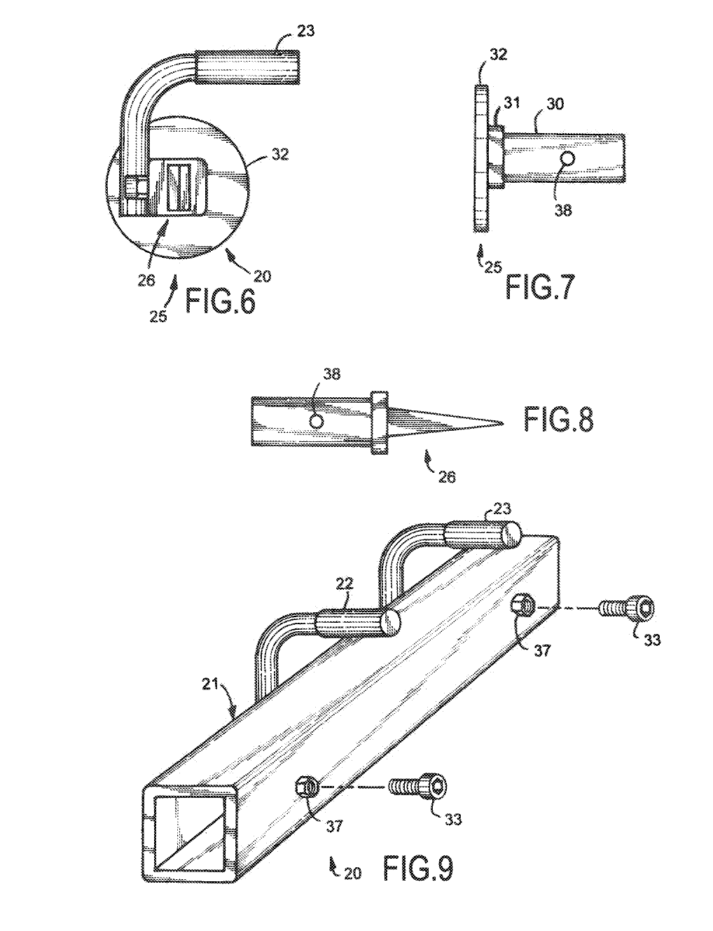

FIG. 11 is an exploded perspective view of FIG. 10.

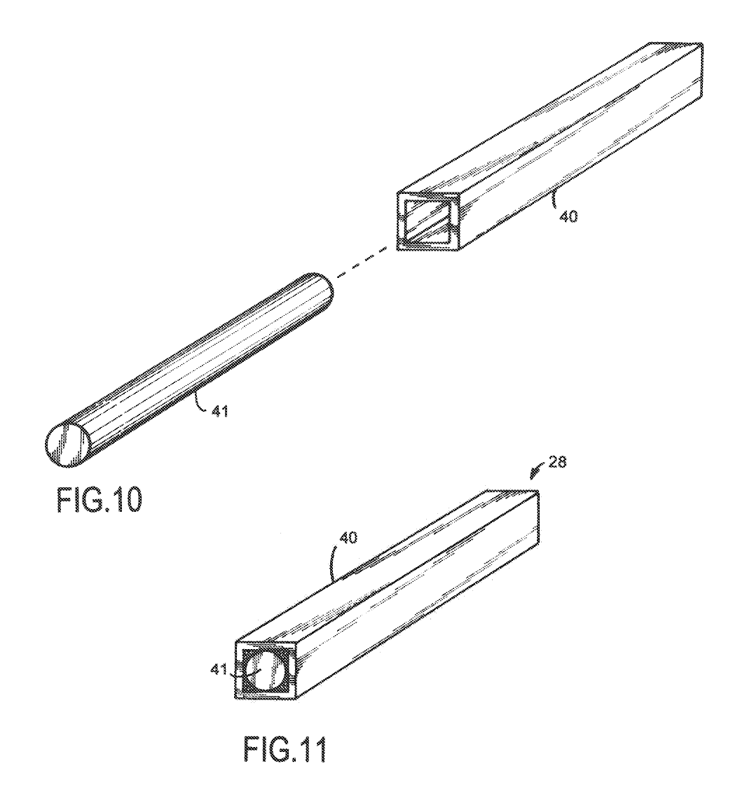

### DETAILED DESCRIPTION OF PREFERRED EMBODIMENTS

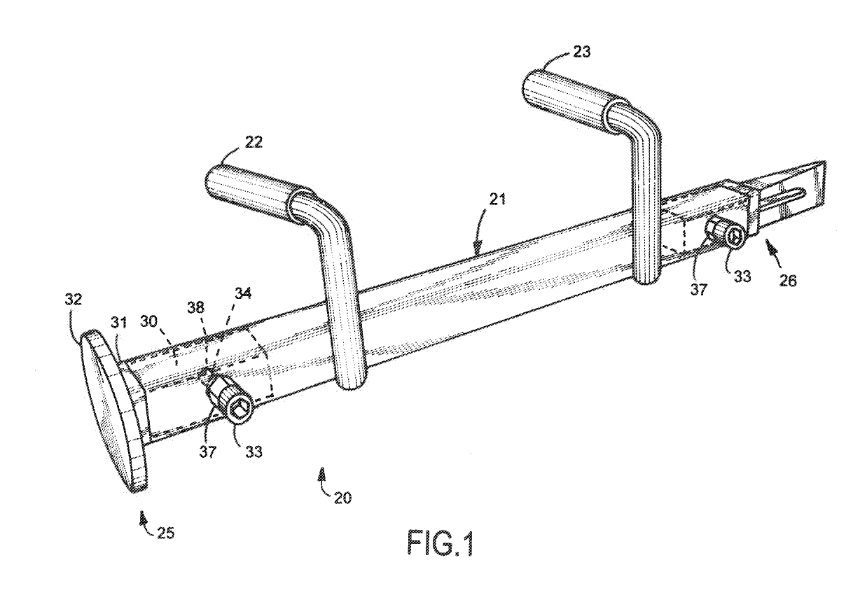

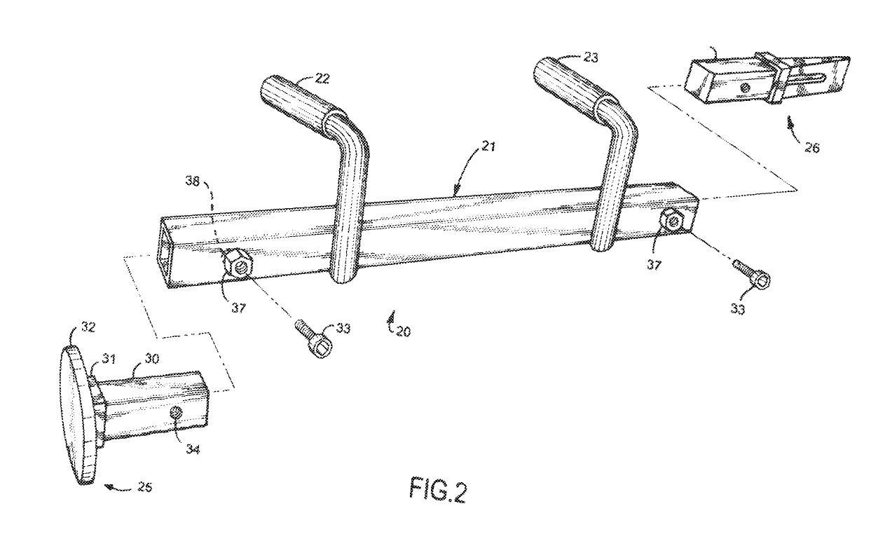

A battering ram 20 (FIGS. 1-2) includes an elongated tubular body 21 (also called a “weldment” herein) with opposing open ends and a pair of laterally-extending L-shaped handles 22, 23 that can be grasped for swinging the body 21 against a door to break the door down. Interchangeable impact heads, such as heads 25, 26 (FIGS. 1, 7 and 8), are provided, each having an elongated male section 30 that fits into a selected one of the open ends of the body 21, a flange 31 abutting the end when the male section 30 is in the body 21, and an operative end 32 configured to generate a desired impact against the door. A retainer 33 threads through a hole 34 in the body 21 to retain the head 25 (or head 26) to the body 21, but with the flange 31 transferring energy from the impact against the door and not into the retainer 33. The plurality of impact heads are particularly shaped for specific different tasks, such as enlarged “oversized” head 25 (which is larger in diameter and surface area than a transverse cross section through the body 21) for weight and large surface, and the wedge-shaped head 26 for prying/wedging. It is noted that alternative heads can be constructed. For example, an “undersized” head can be made similar to head 25, but which alternative head is smaller in diameter or shape than the cross section through the body 21, such as for generating a more focused but blunt high-energy force to damage to a particular door. For example, the smaller head can have a round similar shape to operative end 32 of the head 25, but where its diameter is less than a maximum outer dimension of the body 21 (such as 50% to 75% of the outer dimension of the body 21).

The illustrated components of ram 20 are made of metal and make up a total weight of between about 35 to 65 pounds, depending on which head is attached and depending on a weight preference of the purchaser/user. In one form, the body 21 is cut from square tubular stock, such as 2″ square metal stock frame with internal cavity of 1½″×1½″ size. L-shaped handles 22/23 (or looped handles) are welded onto sides of the body 21 at locations spaced from the ends of the body 21 and at a spacing convenient for gripping and swinging the battering ram 20. The head 25 (and head 26) includes a male section 30 with square cross section of about 1½″×1½″ that is configured to fit matably into the internal cavity of the body 21, with the flange 31 abutting one of the ends of the body 21. A weld nut 37 (FIG. 2) is welded over the hole 34 in the body 21 at each end. It is contemplated that the weld nut 37 is in a location matching a recess 38 in the male section 30. A retainer 33 (e.g., a ⅝″ diameter headed screw) is threaded through nut 37 and hole 34 into the recess 38, thus retaining the head 25 (and/or head 26) to the body 21. The headed screw retainer 33 is not damaged during use of ram 20 due to the flange 31 which communicates force from the head to the body 21 without concurrently creating large stress and/or shearing forces on the retainer 33. It is noted that the head 25 (and head 26) can be manufactured by various means and of different materials.

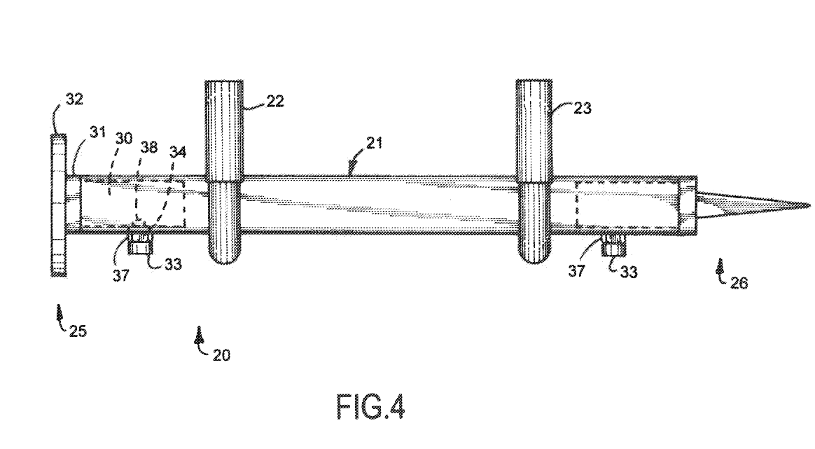

In one form, a weighted member 28 (FIGS. 7 and 8) is provided that is made of a square tube section 40, such as about 16″ long and 1½″×1½″ outer size to fit within the body 21, and an inner shaft 41. The weighted member 28 can be used in place of the solid metal male section 30. Alternatively, the weighted member 28 can be constructed to fit within the body 21 to provide additional weight to the ram 20.

In member 28, the inner solid bar shaft 41 has a round cross section and is welded into the outer tube 40 at a desired longitudinal location on outer tube 40. If desired, a flange 31 (see FIG. 1) can be welded to a side of the outer tube section 40 or to an end thereof, depending on the functional requirements of the member 28 being constructed. For example, the flange 31 can be a ring cut from metal plate with the desired shape and size, and if desired may include a hole for inner shaft 41 to extend through (thus allowing the shaft 41 to be longer than tube section 40). Thus, the shaft 41 would provide the “undersized” head discussed above that is similar to (but smaller than) head 25.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A battering ram comprising:
an elongated tubular body with at least one open end and a pair of laterally-extending handles that can be grasped for swinging the body against a door;
a replaceable impact head with an elongated male section fit into the open end of the body, a flange abutting the end when the male section is in the body, and an operative end configured to generate a desired impact against the door; and
a retainer releasably securing the head to the body, but with the flange transferring energy from the impact against the door and not transferring substantial energy to the retainer.

2. The battering ram defined in claim 1, wherein the operative end of the impact head defines an impacting surface at least as large as a transverse cross section of the body.

3. The battering ram defined in claim 1, wherein the operative end of the impact head defines an impacting surface smaller than a transverse cross section of the body.

4. The battering ram defined in claim 1, wherein the operative end of the impact head defines an impacting tip that forms a narrow wedge.

5. The battering ram defined in claim 1, wherein the impact head has a first weight, and including a second head having a second weight and shape different than the first-mentioned impact head.

6. The battering ram defined in claim 1, wherein the retainer includes a threaded screw that threads through the body and that has a tip engaging a mating recess in the head.

7. The battering ram defined in claim 1, wherein the body includes two of the open ends.

8. A battering ram system comprising:
an elongated tubular body with an open end and a pair of laterally-extending handles that can be grasped for swinging the body against a door;
a plurality of interchangeable impact heads each having an elongated male section fit into the open end of the body, a flange abutting the end when the male section is in the body, and an operative end configured to generate a desired impact against the door; and
a retainer retaining the head to the body, but with the flange transferring energy from the impact against the door and not transferring substantial energy to the retainer;
the plurality of impact heads including a first impact head where the operative end of the impact head defines an impacting surface at least as large as a transverse cross section of the body, a second impact head where the operative end of the impact head defines an impacting surface smaller than a transverse cross section of the body, and a third impact head where the operative end of the impact head defines an impacting tip that forms a narrow wedge.

9. The battering ram defined in claim 8, wherein the body includes two of the open ends.

10. A method of constructing a battering ram system comprising steps of:
providing an elongated tubular body with an open end and a pair of laterally-extending handles that can be grasped for swinging the body against a door;
providing a plurality of interchangeable impact heads each having an elongated male section adapted to fit into the open end of the body, a flange abutting the end when the male section is in the body, and an operative end configured to generate a desired impact against the door;
selecting one of the impact heads for a particular task; and
retaining the selected one head to the body using a retainer on the body, but with the flange being constructed to transfer energy from the impact against the door and not transferring substantial energy to the retainer; whereby the plurality of impact heads can be selectively replaced for specific needs.

11. The method defined in claim 10, wherein the plurality of heads includes a first impact head where the operative end of the impact head defines an impacting surface at least as large as a transverse cross section of the body, a second impact head where the operative end of the impact head defines an impacting surface smaller than a transverse cross section of the body, and a third impact head where the operative end of the impact head defines an impacting tip that forms a narrow wedge; and wherein the step of selecting includes selecting one of the first, second, and third impact heads.
